(19) United States
(12) Patent Application Publication
(10) Pub. No.: US 2017/0361644 A1
(43) Pub. Date: Dec. 21, 2017

(54) SURFACE SCRAPER TOOL

(71) Applicant: Thomas Jay Landwehr, DePere, WI (US)

(72) Inventor: Thomas Jay Landwehr, DePere, WI (US)

(21) Appl. No.: 15/185,136

(22) Filed: Jun. 17, 2016

(51) Int. Cl. B44D 3/16; A47L 1/06

(52) U.S. Cl. CPC B44D 3/164; A47L 1/06

(57) ABSTRACT

A surface scraper tool for removing coating from a smooth flat surface with a blade holder having a bottom surface defining a surface plane and a lateral guide face defining a guide plane and with a blade protruding from the front of the blade holder forming a predefined scraping angle with the surface plane and a sharp edge extending across the whole width of the blade holder in the surface pane and not extending beyond the guide plane.

### FIELD OF THE INVENTION

The present invention relates to a surface scraper tool for removing coating from a smooth flat surface.

### BACKGROUND OF THE INVENTION

Various activities involve application of a coating to a smooth and flat surface with an adhesive or paint. This may happen intentionally in the context of glass painting or when applying privacy or other protective films to windows. After some time it may be desirable to remove the applied coating again, which often needs to be scraped off with a blade because it cannot be removed easily. More commonly, the unwanted coating is applied accidentally when working on a nearby surface, for example when a window frame is being repainted. While this effect can be minimized by applying masking tape before painting the frame, it cannot always prevent at least some paint from being applied to the window. Sometimes, in order to reduce the time to complete the job, no masking tape is applied and inevitably some of the paint ends up on the window pane.

Many types of scrapers specially designed for removing paint from window panes or other coatings from flat surfaces already exist. In U.S. Pat. No. 4,955,138, a scraper is disclosed with a blade sharp enough to get under the coating, allowing it to be lifted from the flat surface rather than pushing it forward, which requires more force. It is also mentioned that the blade holder secures the blade according to a specific angle with respect to the flat surface in order to ensure maximum scraping efficiency. A similar device is shown in U.S. Pat. No. 4,709,478. In addition to the above-mentioned features, the presented device has long left and right side walls that can be used as guides when scraping along a window frame for example, without damaging it. The bodies of both presented devices slide on the flat surface of the object to scrape, which allows guiding the devices in a stable manner when scraping.

When removing the coating, it is important that no residues are left in areas that are difficult to access, for example in the corner of a window. With the existing devices, this is not easily possible and may require guiding the blade very carefully in order to prevent the surrounding material from getting damaged, since the known devices feature rectangular/right-angled blades that can only reach the corner when they are perfectly placed. In addition, when scraping along the edges, no peripheral strip of coating must be left untouched, while at the same time the surrounding material should not be damaged. Again, this is almost impossible with the existing devices due to the shape of the blades. Therefore, an inexperienced user who tries to remove all of the coating along a window edge and/or in a corner is very likely to scratch or damage the window frame unless he is extremely cautious.

Also, it is important for the blade holder or the device to slide easily on the object to scrape, without scratching the flat surface or the surroundings. Existing devices are based on the assumption that the device will slide nicely provided that it features substantially flat “interior” surfaces. While the surface to be cleaned is usually flat, even and smooth, this is not necessarily true for the surrounding surfaces, such as a window frame. And, if the user pushes the scraper against the object or leans on it to increase the force applied in addition to pushing it forward, the surfaces could be scratched especially if something is caught between them and the device.

The blade used for such scraping applications typically has a very sharp edge and is therefore dangerous when handled by the user. These blades cause safety issues when the scraper is not stored safely as soon as it is collected from the storage and also every time the blade needs to be replaced. The latter situation is critical, since the blade has to be manipulated directly. The user has to be very careful to avoid getting injured, which can be a problem for the occasional user since he may not have the required skill to perform this manipulation safely. Concerning the storage of the scraper, for some existing devices, the blade can be retracted into a housing, or placed in a sheath or its edge is covered by a guard when it is stored. While in this way, the hazard the blade represents is removed, it does require additional manipulations or extra parts need to be kept with the device.

### SUMMARY OF THE INVENTION

A first object of the present invention is to facilitate the scraping of the coating from flat surfaces in areas that are difficult to access. This is achieved by using a specific shape of the blade holder and of the blade holder, which is oriented according to the requirement of the invention.

A second object of the present invention is to improve the contact surfaces between the scraper and the object by enabling the scraper to slide more easily on the object and preventing the object surfaces from being damaged.

A third object of the present invention is to prevent the user from getting injured by removing the need of manually handling sharp blades and by providing a means of automatically guarding the sharp edge when the tool is not being used.

### BRIEF DESCRIPTION OF THE DRAWINGS

FIG. 1 Perspective view of the surface scraper tool

FIG. 2 Lateral view of the surface scraper tool

FIG. 3 Top view of the surface scraper tool

FIG. 4 Front view of the surface scraper tool with a longitudinal bevel

FIG. 5 Top view of a surface scraper tool for dual use with two blades

FIG. 6 Perspective view of a surface scraper tool for dual use with one blade

FIG. 7 Top view of a surface scraper tool with a blade removable guard

FIG. 8a Top view of a surface scraper tool with a blade guard pivoting horizontally on the blade holder: closed position

FIG. 8b Top view of a surface scraper tool with a blade guard pivoting horizontally on the blade holder: open position

FIG. 9a Top view of a surface scraper tool with a blade guard pivoting vertically on the blade holder: closed position

FIG. 9b Top view of a surface scraper tool with a blade guard pivoting vertically on the blade holder: open position

### DETAILED DESCRIPTION OF THE INVENTION

Preferred embodiments of the surface scraper tool are described according to the drawings. These preferred embodiments are to be understood as exemplary embodiments and any detailed description shall not be interpreted as limiting. In particular, the present surface scraper tool may be used for any purpose, be it for scratching, scraping or propelling fluids on any kind of surface. Alternate embodiments obvious to one skilled in the art will not be described in detail or will be omitted to prevent the relevant details of the invention to be overlooked.

The surface scraper tool is aimed at scraping a substantially smooth and flat surface of an object whose coating is to be removed. For example, the object may be a window pane or a wooden surface covered by paint, stickers or other types of coatings.

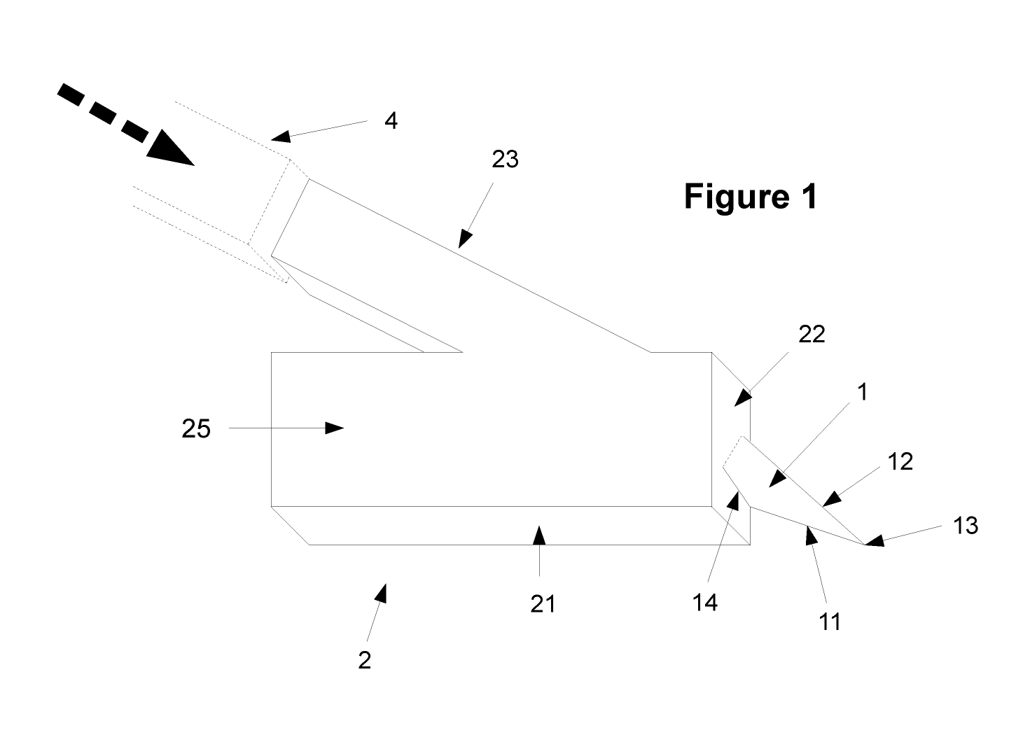

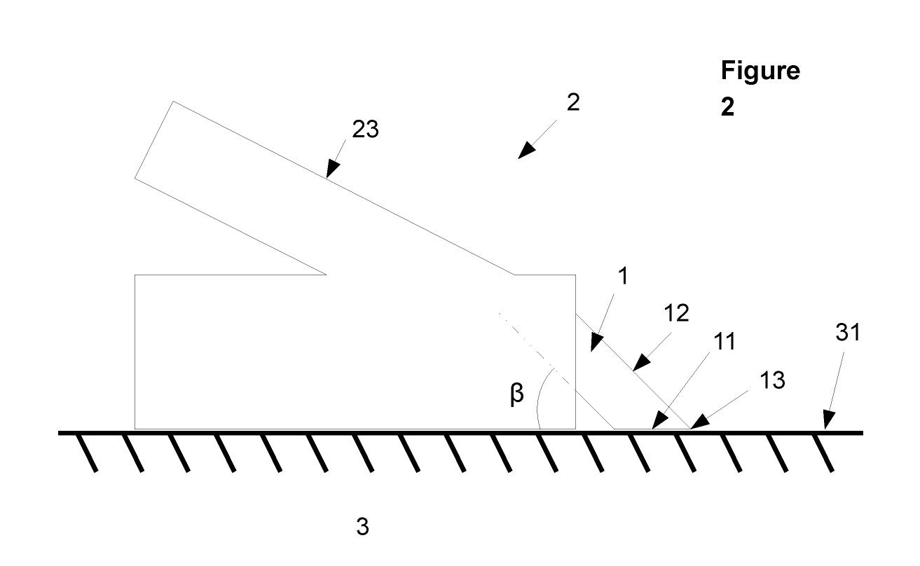

The surface scraper tool comprises a blade 1 and a blade holder 2 (FIG. 1). The blade 1 protrudes from the front face 22 of the blade holder 2 and is oriented and shaped in such manner that its front sharp edge 11 lies entirely in the surface plane defined by the substantially flat bottom surface 21 of the blade holder 2. The surface scraper tool is used by placing the bottom surface 21 in contact with a surface 31 (FIG. 2). By doing so, the sharp edge 11 of the blade 1 is also in contact with the surface 31 over its whole length. This sharp edge 11 allows the blade 1 to cut through the coating, get under it and lift it from the surface 31 when the surface scraper tool is moved forward. The sharp edge 11 can be a V-edge, a chisel edge, a compound bevel edge or any other commonly known edge.

In order to reach the maximum scraping efficiency, i.e. the most efficient transmission of the user's force to the interface between the coating and the substrate, the blade should at a specific scraping angle β with respect to the surface 31. A too small scraping angle β can prevent the blade from cutting through the coating and separating it from the object to scrape 3 whereas a too large scraping angle β results in the coating being pushed forward rather than lifted from the surface, which requires a much stronger force. The scraping angle β is an acute angle which is often between 5 and 45 degrees. The ideal angle depends on the type of coating and the type of object to scrape. Best results are obtained if the scraping angle is between 15 to 25 degrees.

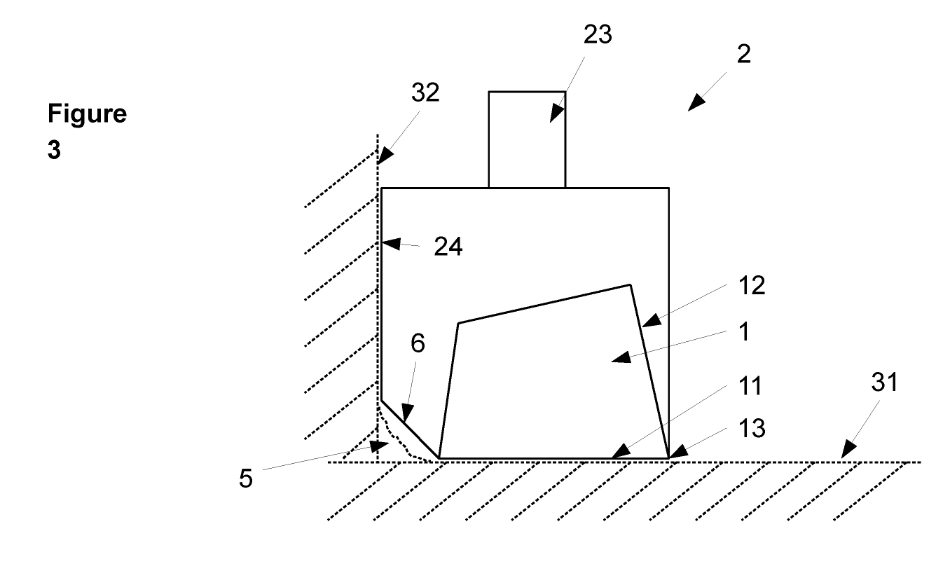

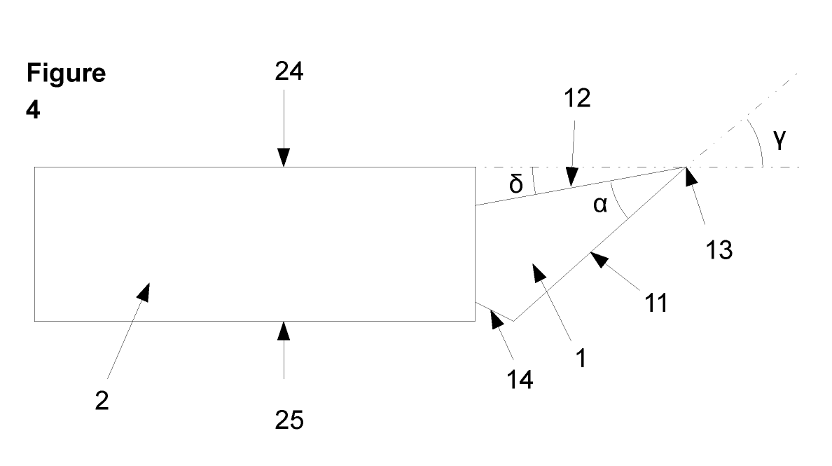

When scraping along surrounding parts 32 which shouldn't be scratched, e.g. a window frame, it is important to prevent the blade 1 from touching or bumping into it (FIG. 3) to prevent damaging these surrounding parts. This requires the scraping direction to be parallel to the surroundings 32 and at a controlled distance therefrom, which should be as close as possible to zero. The lateral guide face 24 (FIGS. 3 and 4) forms a guide plane and slides on the surroundings 32, guiding the surface scraper tool parallel thereto and preventing the blade 1 from pivoting towards them by accident as long as the tool is in full contact with the surroundings. In order to to provide a stable guiding, the lateral guide face 24 should represent substantially the whole length of the blade holder 2. The lateral extension of the blade 1 is limited by the guide plane defined by the lateral guide face 24 (FIG. 4) in order to prevent damage to the surroundings. The blade tip 13 may lie in the guide plane, in order to make sure that no peripheral strip of coating is left when scraping around the surroundings 32. The rest of the blade 1, however, should stay away from the guide plane to avoid damage. For example, as shown FIG. 4, the side edge 12 of the blade 1 on the side of the guide plane may form an angle δ with the guide plane, to prevent that part of the blade from contacting the surroundings.

As a further improvement, the sharp edge 11 of the surface scraper tool forms an angle γ with respect to the guide plane as seen in the top view of FIG. 4. This angle γ is an acute angle ideally less then 90°. As a result, the blade tip 13 is the foremost point of the blade 1 and forms an angle perfectly suited for removing coating in areas that are very difficult to access like recesses and corners.

In one configuration, the sharp edge 11 removes the material present on the surface of the object 3 in the immediate vicinity of the guide plane. While this may be desirable for a clean scraping along the surroundings 32, there are cases where the scraping should leave a peripheral strip of material untouched. For example, windows can be embedded into the frame with a peripheral strip of glazing putty 5, as shown FIG. 3. In order to prevent this material 5 from being removed or damaged and keeping the contact between the lateral guide face 24 and the surrounding window frame, the blade holder 2 may feature a bevel 6 in the longitudinal direction between the surface plane and the guide plane. In such an embodiment, the sharp edge of the blade 1 is located a distance away from the guide plane.

In order to improve the contact between the surface scraper tool and the object to scrape 3, the bottom face 21 of the blade holder 2 can be made of or coated with a material that slides easily on a surface such as glass and doesn't scratch the object 3 during the scraping. For example, a polymer with low hardness can be used which does not scratch an object 3 made of glass or wood. In addition, the bottom face 21 may feature longitudinal creases or grooves, which have two advantages. First, the contact surface between the blade holder 2 and the object to scrape 3 is limited to the ridges of the grooves. Thanks to this reduced contact surface the smaller friction force allows the surface scraper tool to slide more easily on the surface. Second, an object featuring grooves has a lower friction coefficient in the direction of the creases than in the direction perpendicular to the creases, which makes it more likely that the surface scraper tool is moved parallel to the grooves and correspondingly the surrounding window frame. This improves the stability of the surface scraper tool and makes it easier to guide.

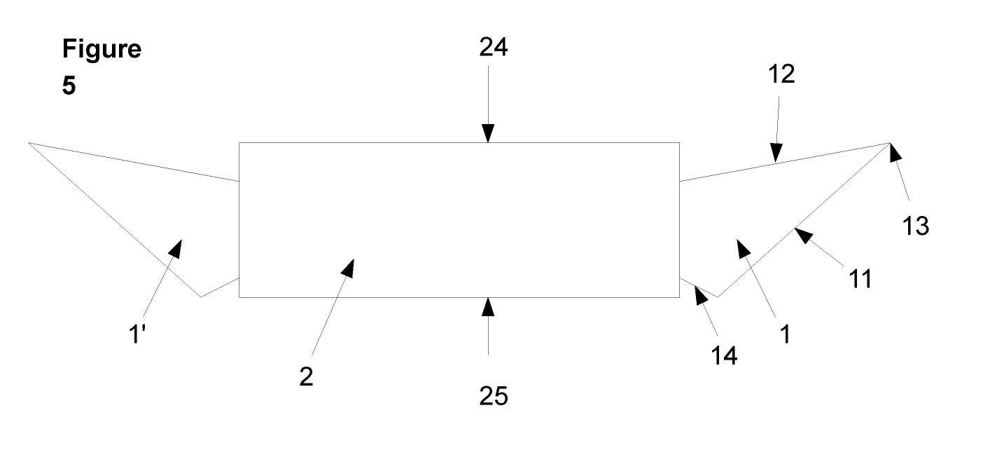

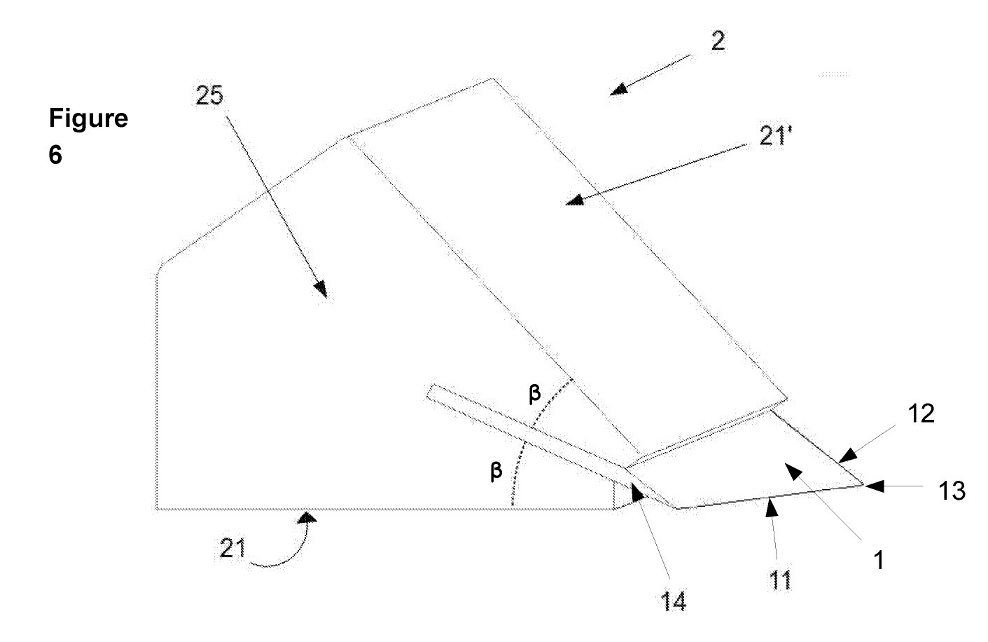

As can be seen from FIG. 4 the foremost point of the sharp edge 13 is located on one side of the scraper tool. When trying to scrape in a corner of a window this tool can only be used from one side. Therefore, in a further embodiment shown FIG. 5, the scraper tool comprises two blades 1, 1′ symmetrically arranged on opposite sides of the blade holder 2. This resolves the issue of scraping along surroundings 32 on the left or right side of the scraper tool.

Alternatively, the surface scraper tool may only comprise a single blade 1 and two symmetrically arranged bottom surfaces 21, 21′ forming the same scraping angle β with the blade 1. Thus, the blade tip 13 can be located on the left side of the scraper when the bottom face 21 is in contact with the object to scrape 3, or on the right side in case the bottom face 21′ is in contact with the object 3.

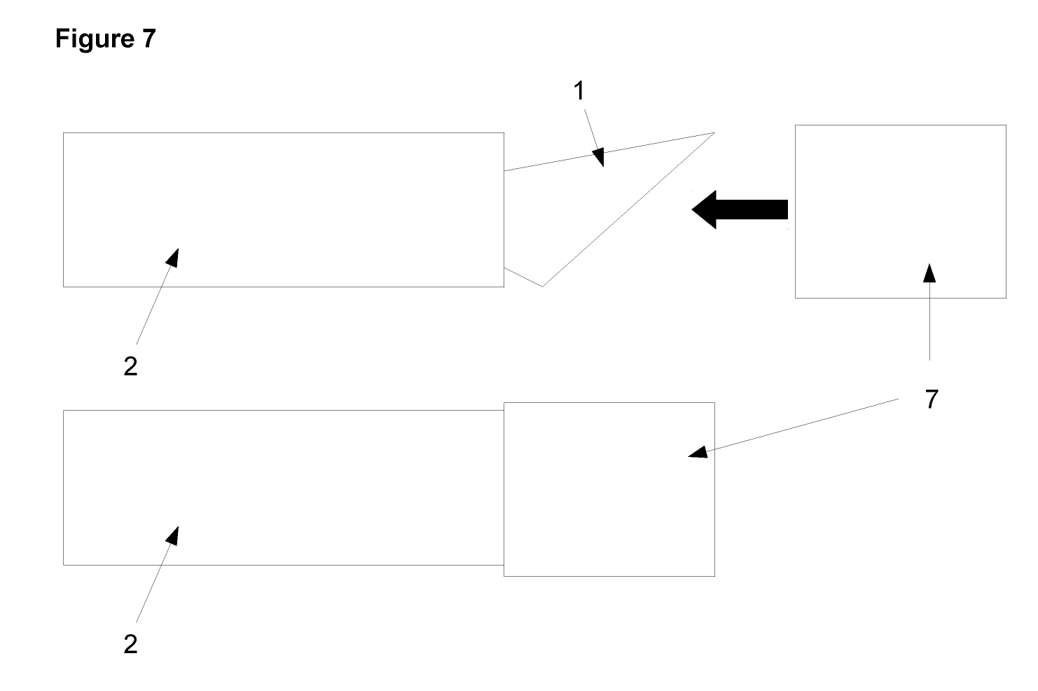

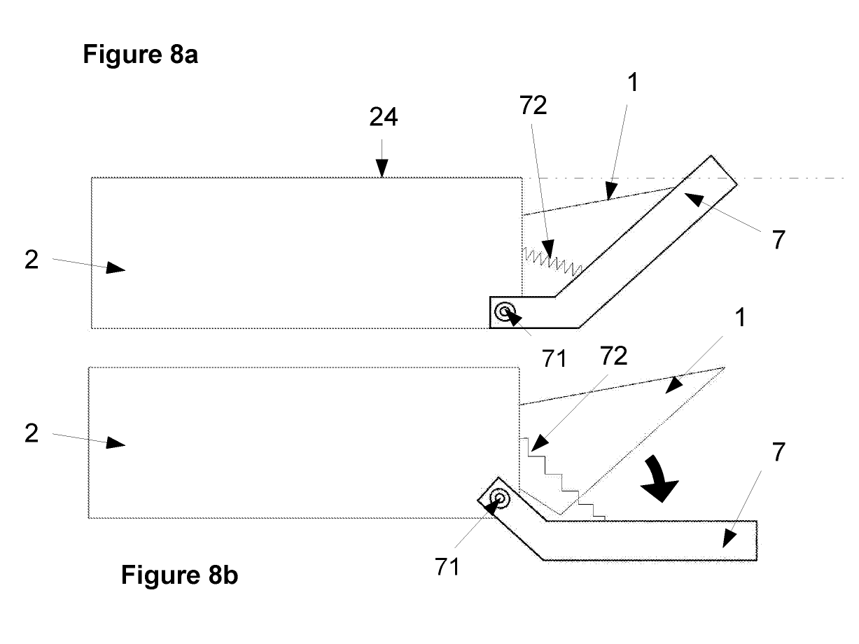

Often the object to be scraped 3, such as a ceiling or a high window is not located where it can be reached easily. Thus, using a ladder may be required. In these situations, the user may only have one hand to hold the scraper tool, because the other hand is used for holding himself on the ladder or supporting himself in another manner. When exerting a force on the surface scraper tool, it may be difficult to keep balance and the tool or, even worse, the user himself may fall. Therefore, it is important that the scraper tool is safe and the user is protected in the best possible way. This is achieved by providing the surface scraper tool with a blade guard 7. This blade guard 7 can be arranged on the surface scraper tool in a manner covering the cutting edge 11 of the blade 1 entirely, and removed prior to use (FIG. 7). FIG. 7 shows a blade guard 7 which is completely detached from the surface scraper tool when uncovering the blade 1. In order to avoid loosing the blade guard 7 when uncovering the blade 1, one end of the blade guard 7 may be connected to the surface scraper tool even when the cutting edge 11 of the blade 1 is uncovered. For example, the blade guard 7 may be attached pivotally to the surface scraper tool as shown in FIG. 8. In this embodiment, the blade guard 7 pivots from a protected position where it covers the cutting edge 11 entirely (FIG. 8a) to an open position in which the cutting edge 11 is exposed and can be used for scraping (FIG. 8b). The pivoting of the blade guard 7 from the open position into the protected position may be done manually. The blade guard 7 can also be connected with the surface scraper tool via a spring 72 which constantly forces the blade guard into the protected position. This way, the cutting edge 11 of the blade 1 is automatically covered as soon as the blade guard 7 is released. Preferably the blade guard 7 is not pivoted from the protected position into the open position manually, but automatically as soon as the surface scraper tool is pushed against an object 3. As shown FIG. 8a in an exemplary embodiment, the blade guard 7 can extend beyond the guide plane. When the lateral face 24 of the surface scraper tool is pushed against surroundings 32, such as a window frame, the front end of the blade guard is pivoted by the window frame, and thus exposes the blade 1.

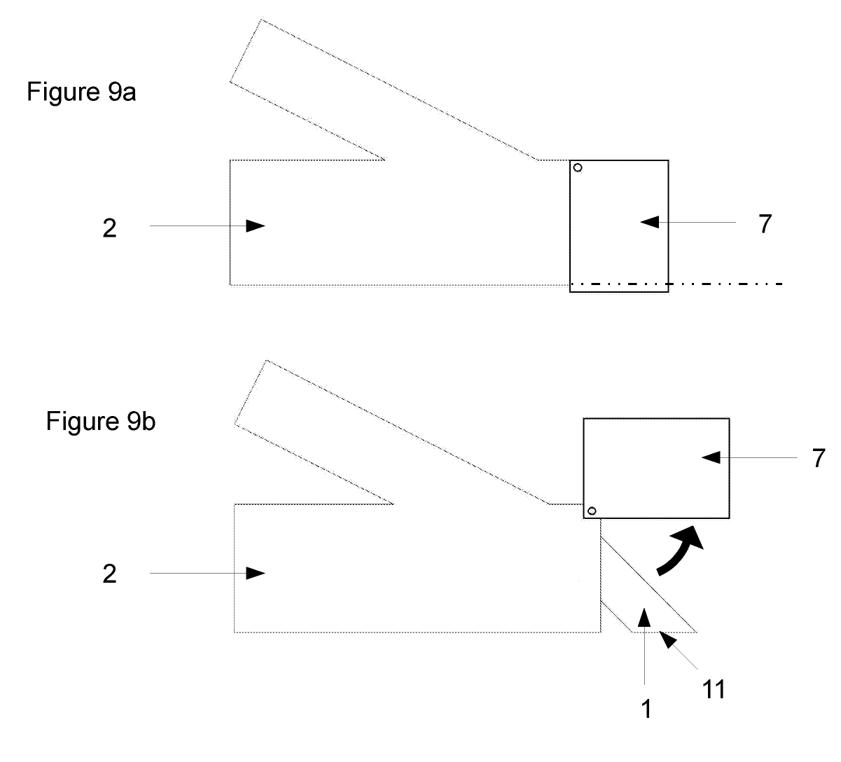

In a further embodiment, the blade guard 7 may pivot vertically around the blade holder 2: up into the open position and down into the protected position (FIG. 9). In this embodiment, as shown FIG. 9a, the blade guard 7 can extend beyond the surface plane. When the bottom face 21 of the surface scraper tool is pushed against the flat surface of an object to scrape 3, the blade guard 7 is pushed upwards and away from the flat surface 31, exposing the blade.

In some environments use of a ladder for is limited such as in a stairwell or the window to be scraped is located horizontally in a location that is hard to reach. In such cases the blade holder 2 may comprise a means 23 for securing an additional handle 4, e.g. a pole (FIG. 1). This allows the user to reach remote areas easily. Another advantage is that the user can stand comfortably on the floor, so both his hands are free for directing and pushing the surface scraper tool. This makes the operation easier and more efficient.

This description and the accompanying drawings show exemplary embodiments of the invention. The invention, however, should not be interpreted as being limited to these particular embodiments. Variations of the embodiments can be made by those skilled in the art without departing from the scope of this invention as defined by the claims.

1. A surface scraper tool comprising
a blade holder
with a bottom surface that is substantially flat defining a surface plane
with a lateral guide face that is substantially flat defining a guide plane
a blade
protruding from the front face of the blade holder,
forming a predefined scraping angle with respect to the surface plane,
with a sharp edge
lying completely in the surface plane extending essentially across the whole width of the blade holder
wherein
said sharp edge does not extend beyond the guide plane.

2. The surface scraper tool according to claim 1,
wherein
said sharp edge forms an acute angle with said guide plane.

3. The surface scraper tool according to claim 1,
wherein
a first end of said sharp edge lies in the guide plane.

4. The surface scraper tool according to claims 2 and 3,
wherein
said first end of the sharp edge is the foremost point of the blade.

5. The surface scraper tool according to claim 1,
wherein
the scraping angle is an acute angle.

6. The surface scraper tool according to claim 1,
wherein
the sharp edge is a V-edge, a chisel edge, a compound bevel edge or any other commonly known edge.

7. The surface scraper tool according to claim 1,
wherein
said bottom surface of the blade holder is coated with a material that does not scratch other materials.

8. The surface scraper tool according to claim 1,
wherein
said bottom surface of the blade holder is equipped with guide grooves oriented in the longitudinal direction.

9. The surface scraper tool according to claim 1,
wherein
said blade holder contains a bevel in the longitudinal direction between the surface plane and the guide plane
said cutting edge does not extend beyond the intersecting line formed by the bevel and the surface plane.

10. The surface scraper tool according to claim 1
further comprising
a second blade symmetrically arranged on the opposite side of the blade holder.

11. The surface scraper tool according to claim 1,
wherein
the blade is fixed to the blade holder.

12. The surface scraper tool according to claim 1,
wherein
said tool is a single-use tool.

13. The surface scraper tool according to claim 1,
wherein
a blade guard is removably attached to the tool such that the sharp edge is completely covered by the blade guard.

14. The surface scraper tool according to claim 1,
wherein
a blade guard is attached to the tool at a pivot point
the blade guard covering the sharp edge in the protected position and
exposing the sharp edge in the open position
said open position achieved by pivoting the blade guard away from the tool.

15. The surface scraper tool according to claim 14,
wherein
a spring permanently forces the blade guard towards the protected position.

16. The surface scraper tool according to claim 15,
wherein
the blade guard is L-shaped and
a first end of the blade guard is connected to the blade holder at a pivot point.

17. The surface scraper tool according to claim 16,
wherein
the blade guard pivots in a plane parallel to the surface plane and
a second end of the blade guard extends beyond the guide plane.

18. The surface scraper tool according to claim 17,
wherein
pushing the tool against a surface on the guide plane forces the second end of the blade guard away from the guide plane and into the open position.

19. The surface scraper tool according to claim 16,
wherein
the blade guard pivots in a plane parallel to the guide plane and
a second end of the blade guard extends beyond the surface plane.

20. The surface scraper tool according to claim 19,
wherein
placing the tool against on surface with the surface plane forces the second end of the blade guard away from the surface plane and into the open position.
